(19) United States
(12) Patent Application Publication
(10) Pub. No.: US 2025/0238905 A1
(43) Pub. Date: Jul. 24, 2025

(54) Video Diffusion Model

(71) Applicant: Google LLC, Mountain View, CA (US)

(72) Inventors: Inbar Mosseri, Raanana (IL); Omer Bar Tal, Mountain View, CA (US); Hila Chefer-Livshen, Tel Aviv (IL); Omer Tov, Kadima-Zoran (IL); Charles Irwin Herrmann, Boston, MA (US); Rony Paiss, Givataim (IL); Shiran Elyahu Zada, Tel Aviv (IL); Ariel Ephrat, Efrat (IL); Junhwa Hur, Cambridge, MA (US); Guanghui Liu, Seattle, WA (US); Amit Raj, Seattle, WA (US); Yuanzhen Li, Newton Centre, MA (US); Michael Rubinstein, Natick, MA (US); Tomer Michaeli, Zichron Yaakov (IL); Oliver Wang, Seattle, WA (US); Deqing Sun, Boston, MA (US); Tali Dekel, Arlington, MA (US)

(21) Appl. No.: 19/034,368

(22) Filed: Jan. 22, 2025

Related U.S. Application Data
(60) Provisional application No. 63/623,735, filed on Jan. 22, 2024.

(51) Int. Cl. G06T 5/60; G06T 3/4046; G06T 3/4053; G06T 5/70; G06T 11/00; G11B 27/34

(52) U.S. Cl. CPC G06T 5/60; G06T 3/4046; G06T 3/4053; G06T 5/70; G06T 11/00; G06T 2207/10016; G06T 2207/20084; G11B 27/34

(57) ABSTRACT

Provided is a video generation model for performing text-to-video (T2V) or other video generation techniques. The proposed model reduces the computational costs associated with video generation. In particular, unlike traditional T2V methods, the disclosed technology can generate the full temporal duration of a video clip at once, bypassing the need for extensive computation. As one example, a machine-learned denoising diffusion model can simultaneously process a plurality of noisy inputs that correspond to various timestamps spanning the temporal dimension of a video to simultaneously generate synthetic frames for the video that match the timestamps.

### RELATED APPLICATIONS

This application claims priority to and the benefit of U.S. Provisional Patent Application No. 63/623,735, filed Jan. 22, 2024. U.S. Provisional Patent Application No. 63/623,735 is hereby incorporated by reference in its entirety.

### FIELD

The present disclosure relates generally to video generation using machine learning models, and more specifically to a machine-learned denoising diffusion model for generating videos that portray realistic, diverse, and coherent motion.

### BACKGROUND

The creation of synthetic videos has a broad range of applications, including entertainment, virtual reality, and training simulations. Traditionally, video generation, particularly text-to-video (T2V) generation, has been a computationally intensive task due to the high dimensionality of video data and the need for global coherence in the generated motion. Existing methods often involve inflating a pre-trained text-to-image (T2I) model by adding temporal layers, which results in excessive computational costs. Furthermore, these methods tend to produce videos with limited global motion coherence due to temporal aliasing ambiguities, especially when synthesizing videos with low frame rates.

Another technical problem is the high memory consumption of spatial super-resolution (SSR) models when they are adapted for video generation. The SSR models are used for transforming low-resolution video frames into high-resolution video frames. However, the memory requirements for processing a large number of high-resolution frames simultaneously are substantial, creating a need for a technical solution that optimizes memory usage while preserving the motion consistency of the generated video.

### SUMMARY

Aspects and advantages of embodiments of the present disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method to perform video generation. The computer-implemented method also includes generating, by a computing system may include one or more computing devices, a plurality of noisy inputs that respectively correspond to a plurality of timestamps that span a temporal dimension of a video. The method also includes simultaneously processing, by the computing system, the plurality of noisy inputs with a machine-learned denoising diffusion model to simultaneously generate, as an output of the machine-learned denoising diffusion model, a plurality of synthetic frames for the video that respectively correspond to the plurality of timestamps of the video. The method also includes where the machine-learned denoising diffusion model may include a plurality of layers. The method also includes where at least a first layer of the plurality of layers performs a temporal downsampling operation to generate a first layer output having a reduced size in the temporal dimension. The method also includes where at least a second layer of the plurality of layers performs a temporal upsampling operation to generate a second layer output having an increased size in the temporal dimension. The method also includes providing, by the computing system, the video as an output.

Other embodiments of this aspect include corresponding computer systems, apparatus, and computer programs recorded on one or more computer storage devices, each configured to perform the actions of the methods.

Implementations may include one or more of the following features. The second layer may be positioned after (e.g., directly after or generally after) the first layer in a processing flow or direction of the machine-learned denoising diffusion model. The computer-implemented method where the plurality of synthetic frames simultaneously generated by the machine-learned denoising diffusion model may include an entirety of the video. The machine-learned denoising diffusion model may include a space-time u-net. The space-time u-net may include a pre-trained u-net that has been inflated with temporal layers. An initial layer of the machine-learned denoising diffusion model and a final layer of the machine-learned denoising diffusion model each have a size in the temporal dimension that matches a number of frames included in the video. The plurality of layers may include two or more convolution-based inflation blocks and at least one attention-based inflation block, where each of the two or more convolution-based inflation blocks and the at least one attention-based inflation block combine pre-trained spatial layers with added temporal layers. Each convolution-based inflation block may include a 2d convolution followed by a 1d convolution with temporal downsampling or temporal upsampling, and where each attention-based inflation block may include a 1d attention operation with temporal upsampling. The machine-learned denoising diffusion model operates in a pixel-space of the video. The plurality of synthetic frames simultaneously generated by the machine-learned denoising diffusion model may include a plurality of low resolution synthetic frames, and the method further may include, prior to providing the video as an output: processing, by the computing system, the plurality of low resolution synthetic frames with a machine-learned spatial-super resolution model to generate a plurality of high resolution synthetic frames for the video. Processing, by the computing system, the plurality of low resolution synthetic frames with the machine-learned spatial-super resolution model may include processing, by the computing system with the machine-learned spatial-super resolution model, each of a plurality of groups of the low resolution synthetic frames that respectively correspond to a plurality of temporal windows. Processing, by the computing system with the machine-learned spatial-super resolution model, each of the plurality of groups of the low resolution synthetic frames may include performing, by the computing system, multi-diffusion across the temporal dimension of two or more of the plurality of groups. The plurality of temporal windows are overlapping, and where performing, by the computing system, multi-diffusion may include performing, by the computing system, multi-diffusion on overlapping temporal portions of the two or more of the plurality of groups. The computer-implemented method may include: receiving, by the computing system, a conditioning input; and conditioning, by the computing system, the machine-learned denoising diffusion model on the conditioning input. The conditioning input may include a textual input.

The conditioning input may include an image input. The image input may include a masked image input. The machine-learned denoising diffusion model may include a plurality of weights that have been derived by interpolating between a base set of weights and a style-specific set of weights. The machine-learned denoising diffusion model operates in a latent-space of the video, and where the machine-learned denoising diffusion model may include at least a decoder to transform from the latent-space of the video to a pixel-space of the video. Implementations of the described techniques may include hardware, a method or process, or computer software on a computer-accessible medium.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram of an example machine-learned video generation model according to example embodiments of the present disclosure.

FIG. 2 depicts a graphical diagram of an example space-time U-Net applied to perform a single denoising step in a pixel space of the video according to example embodiments of the present disclosure.

FIG. 3A depicts a block diagram of an example convolution-based inflation block according to example embodiments of the present disclosure.

FIG. 3B depicts a block diagram of an example attention-based inflation block according to example embodiments of the present disclosure.

FIG. 4 depicts a graphical diagram of an example space-time U-Net applied to perform a single denoising step in a latent space of the video according to example embodiments of the present disclosure.

FIG. 5 depicts an example spatial super resolution model according to example embodiments of the present disclosure.

FIG. 6A depicts a block diagram of an example computing system according to example embodiments of the present disclosure.

FIG. 6B depicts a block diagram of an example computing device according to example embodiments of the present disclosure.

FIG. 6C depicts a block diagram of an example computing device according to example embodiments of the present disclosure.

Reference numerals that are repeated across plural figures are intended to identify the same features in various implementations.

### DETAILED DESCRIPTION

### Overview

Example aspects of the present disclosure are directed to a video generation model designed for synthesizing videos that portray realistic, diverse, and coherent motion. The proposed model addresses a critical challenge in video synthesis, specifically the generation of globally coherent motion over an entire video clip without extreme computational requirements.

Prior techniques for text-to-video (T2V) generation typically inflate a pre-trained text-to-image (T2I) model by inserting temporal layers into an existing T2I model architecture. These methods often result in prohibitively expensive computational requirements due to the high dimensionality of video data. Additionally, these techniques tend to generate videos with limited global coherence due to temporal aliasing ambiguities that exist in low framerate video.

The present disclosure offers a solution to these issues by introducing a machine-learned denoising diffusion model that down-samples the signal in both space and time. In some implementations, this denoising diffusion model can perform the majority of its computation on a compact space-time representation, enabling the simultaneous generation of a significant number of frames (e.g., 80 frames at 16 frames per second) without requiring the use of a cascade of temporal super-resolution (TSR) models. The proposed design is fundamentally different from existing T2V methods, which maintain a fixed temporal resolution across the network.

Another aspect of the present disclosure is directed to an inflation scheme for a pre-trained spatial super-resolution (SSR) model which can operate to increase the resolution of synthetic images generated by the denoising diffusion model. This proposed SSR approach addresses the high memory consumption of the image SSR model when it is inflated to be temporally aware. In particular, the present disclosure extends a multi-diffusion approach to the temporal domain, computing spatial super-resolution on temporal windows and aggregating results into a globally coherent solution over the whole video clip. By performing SSR over smaller windows (while still preserving global motion consistency), computational requirements can be significantly reduced (e.g., as compared to performing SSR over the entire set of frames at once.

More particularly, the present disclosure introduces a novel video generation model for performing text-to-video (T2V) or other video generation techniques. The proposed model reduces the computational costs associated with video generation. In particular, unlike traditional T2V methods, the disclosed technology can generate the full temporal duration of a video clip at once, bypassing the need for extensive computation. As one example, a machine-learned denoising diffusion model can simultaneously process a plurality of noisy inputs that correspond to various timestamps spanning the temporal dimension of a video to simultaneously generate synthetic frames for the video that match the timestamps. For example, the proposed model can generate 80 frames at 16 fps without resorting to a cascade of temporal super-resolution (TSR) models. This design choice allows for the generation of globally coherent motion across the entire video clip.

One aspect of the machine-learned denoising diffusion model that enables the simultaneous generation of the multiple frames is that the machine-learned denoising diffusion model performs downsampling operations in the temporal dimension. In particular, the machine-learned denoising diffusion model can perform a majority of its computations on a more compact representation, which it creates by downsampling the signal in both space and time. As one example, at least one layer of the machine-learned denoising diffusion model performs a temporal downsampling operation, reducing the size of the output in the temporal dimension. Conversely, at least one layer performs a temporal upsampling operation, increasing the size of the output in the temporal dimension. This dynamic resizing of the temporal dimension contributes to the efficiency and effectiveness of the model, as processing operations can be performed with improved efficiency in portions of the model that operate on data having the reduced dimensional size.

In some implementations, the machine-learned denoising diffusion model operates to simultaneously generate multiple low-resolution synthetic frames. These low-resolution frames can then be processed by a machine-learned spatial-super resolution (SSR) model to generate higher-resolution synthetic frames for the video. This two-step process can enhance the quality (e.g., global consistency) of the generated video while maintaining computational efficiency.

Thus, another aspect of the present disclosure is an inflation scheme proposed for a pre-trained spatial super-resolution (SSR) model. The SSR network, responsible for generating high-resolution output, traditionally consumes a significant amount of memory. This memory consumption escalates when inflating the SSR network to be temporally aware across a large number of frames. However, the proposed approach for applying the SSR model over smaller windows, while still preserving global motion consistency, mitigates this issue, promoting efficient memory utilization.

The present disclosure provides a number of technical effects and benefits. As one example, the proposed technology provides improved computational efficiency for video generation. In particular, in some implementations, the machine-learned denoising diffusion model performs temporal downsampling, which reduces the size of the output in the temporal dimension. This downsampling allows for a majority of the model's computations to be conducted on a more compact representation of the video data. By operating on a reduced temporal resolution during the intermediate stages of processing, the model significantly decreases the computational load and memory requirements, allowing for the simultaneous generation of multiple frames of a video sequence. This approach represents a substantial improvement in computational efficiency compared to prior art, which often requires the processing of each frame individually or in small batches.

As another example, the proposed technology provides improved global motion coherence. In particular, the ability to process the entire temporal duration of a video clip at once, rather than relying on a cascade of temporal super-resolution models, ensures that the motion across the video is globally coherent. This is a marked improvement over existing methods that may suffer from temporal aliasing ambiguities due to the generation of isolated keyframes followed by temporal interpolation, which can result in motion inconsistencies and artifacts.

As another example, the proposed technology provides enhanced video quality. In particular, the proposed model includes an inflation scheme for a pre-trained spatial super-resolution (SSR) model that operates over smaller temporal windows while performing multi-diffusion, thereby preserving global motion consistency while still enhancing the spatial resolution of the generated frames and limiting computational cost. By computing spatial super-resolution on overlapping temporal windows and aggregating the results, the model minimizes memory consumption while avoiding the appearance inconsistencies that can arise when stitching together outputs from non-overlapping segments.

In particular, the present disclosure also proposes an alternative to the two extreme approaches of either performing SSR over all frames at once (which is computationally expensive) or performing SSR on isolated temporal windows (which can lead to inconsistencies in appearance at the boundaries between windows). Instead, some example implementations of the present disclosure can extend a multi-diffusion approach to the temporal domain. This can include performing multi-diffusion on overlapping portion(s) of temporal windows to generate globally coherent solution over the entire video clip. This method ensures continuity and coherence in the generated video without leading to extreme computational consumption.

The disclosed technology can operate either in the pixel-space of the video or in the latent-space of the video. When operating in the latent-space, the machine-learned denoising diffusion model can include a decoder to transform from the latent-space of the video to the pixel-space. This flexibility allows the technology to adapt to different video generation requirements and constraints.

The proposed video generation model can be applied to perform a number of different tasks. As an example, the video generation model can be conditioned upon a conditioning input. The conditioning input can be a textual input, an image input, a masked image input, and/or other forms of inputs. This capability allows the technology to generate videos that align with specific user inputs and preferences.

The proposed model can be used in a number of different use cases or applications. One example is text-to-video applications. For example, the model can receive a textual input (e.g., a raw text input or a text embedding) and can generate a video that depicts the content described by the textual input. Another example is image-to-video applications. By fine-tuning the text-to-video model to accept a first frame as conditioning, the model can generate a video sequence that evolves from an initial static image, thereby expanding the utility of the model for scenarios where a starting image is provided to guide the video synthesis process.

Further example applications include video inpainting and outpainting tasks. By fine-tuning the text-to-video model to process masked input RGB frames along with the corresponding masks as binary channels, the model is capable of performing sophisticated video editing tasks. This includes filling in missing regions (inpainting) or extending the frame boundaries (outpainting).

Another example application is image-based stylized generation, which can leverage the strategic choice of training temporal inflation blocks over a pre-trained and fixed text-to-image model. However, a direct application of previous “plug-and-play” approaches for style adaptation has been observed to result in static videos lacking meaningful motion. To address this, the model optimizes a set of spatial text-to-image weights that balance the incorporation of style from fine-tuned weights, denoted as W_{style}, with the original text-to-image weights, denoted as W_{orig}. Through an interpolation process guided by an interpolation coefficient α, the model achieves a blend of style and motion, as evidenced by the generation of videos that exhibit both the desired aesthetic and coherent motion reflective of the learned temporal prior. As one example, some example implementations strike a balance between style and motion by linearly interpolating between the fine-tuned T2I weights, W_{style}, and the original T2I weights, W_{orig}. Specifically, some example implementations construct the interpolated weights as Wᵢₙₜₑᵣₚₒₗₐₜₑ=α·W_{style}+(1−α). W_{orig}. As one example, the interpolation coefficient (e.g., α∈[0.5,1]) can be chosen manually.

Another significant application of the proposed model is in consistent video stylization or editing, a task that poses unique challenges due to the need to understand both spatial and temporal relationships within video frames. While recent methods have been constrained by computational and memory limitations, only allowing for the processing of a limited number of frames, the proposed model overcomes these constraints through its temporal down and upsampling scheme. This enables the processing of entire video clips in a single pass, leveraging the learned spatio-temporal prior for long-duration videos.

With reference now to the Figures, example embodiments of the present disclosure will be discussed in further detail.

### Example Video Generation Models

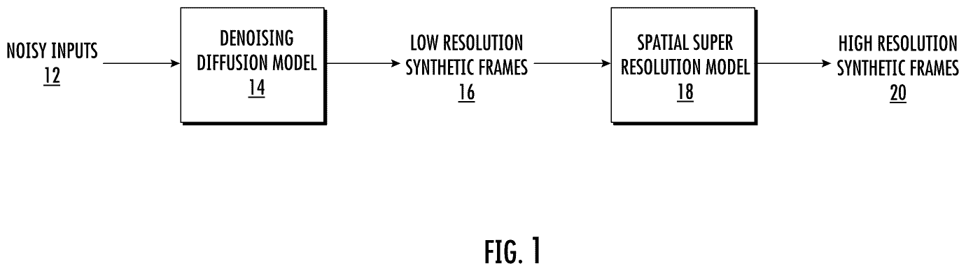

FIG. 1 illustrates a graphical diagram that illustrates the flow and components of an example video generation process as per the disclosed machine-learned video generation model. The figure is a schematic representation of the process from input to output, showcasing the steps involved in generating high-resolution synthetic video frames.

The process begins with noisy inputs (12), which can be noisy representations of video frames at various timestamps. These noisy inputs are the starting point for the video generation process and are intended to be processed by the denoising diffusion model. The noise in the inputs is a part of the diffusion process, which gradually removes noise to generate coherent video frames.

The noisy inputs (12) are fed into the denoising diffusion model (14). This model is a machine-learned component that performs a series of operations to remove noise and generate coherent structures in the video frames. The model can work by denoising the inputs over several denoising time steps, and each denoising time step can include both downsampling and upsampling in the temporal dimension as part of its computation.

The output of the denoising diffusion model (14) is a set of low-resolution synthetic frames (16). These frames represent the video content at a lower spatial resolution, which has been denoised and exhibits coherent motion. However, they are not yet at the high resolution for final output.

The low-resolution synthetic frames (16) are then processed by the spatial super-resolution model (18). This component is responsible for transforming the low-resolution frames into higher-resolution frames. It does this by adding detail and refining the image quality while maintaining the global coherence of the motion in the video.

The final output of the process is the high-resolution synthetic frames (20). These frames are the end product of the video generation model and are expected to have high spatial resolution with realistic, diverse, and coherent motion as portrayed in the video content.

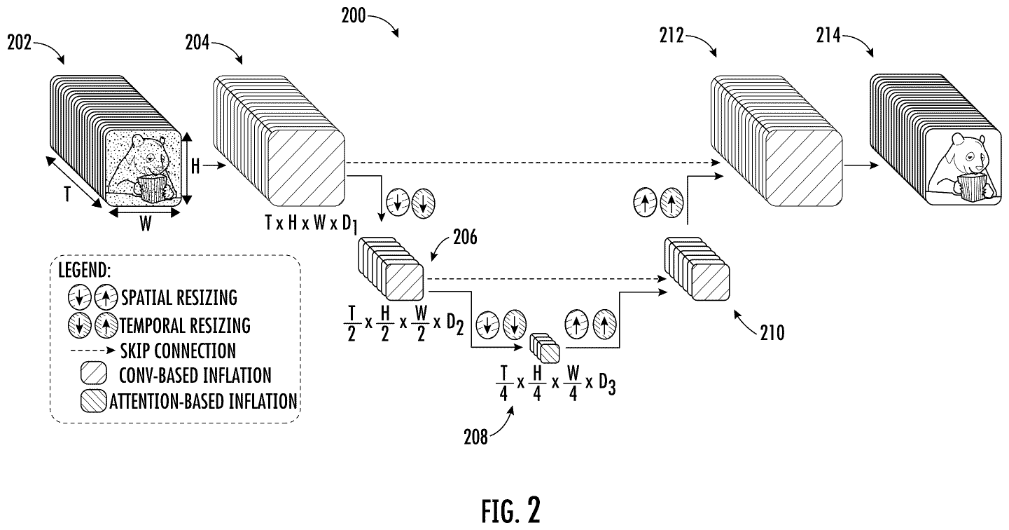

FIG. 2 provides a detailed view of an example space-time U-Net (200), which is a specialized neural network architecture designed to process video data by performing both spatial and temporal downsampling and upsampling. FIG. 2 illustrates the internal structure of the U-Net and the flow of data through its layers.

Noisy input images (202) are can be provided as inputs for the U-Net (200). The noisy input images (202) are noisy frames of a video. The U-Net (200) can process the noisy input images (202) to produce denoised synthetic images.

A first convolution-based block (204) can perform the first spatial and temporal downsampling operation on the noisy input images (202). Downsampling reduces the resolution of the video frames both in space (height and width of the frames) and time (frame rate), which helps in reducing the computational complexity for subsequent processing.

Following the first downsampling, a second convolution-based block (206) further downsamples the data both spatially and temporally. This continued reduction in data size allows the network to extract and process higher-level features at a reduced computational cost.

An attention-based block (208) focuses on specific features within the data for processing. This block can weigh the importance of different features within the frames, allowing the network to concentrate on the most informative parts of the video data. In some implementations, the portion of the model (200) that includes the attention-based block (208) may be referred as a “bottleneck” or, more specifically, as a “temporal bottleneck.”

A third convolution-based block (210) can perform a first spatial and temporal upsampling operation. Upsampling increases the resolution of the video frames in both space and time, starting the process of reconstructing the denoised video frames from the abstracted feature representation.

A fourth convolution-based block performs a second spatial and temporal upsampling. This step continues to refine and enhance the resolution of the video frames, further reconstructing the denoised synthetic images from the compressed feature data.

The final output of the U-Net (200) is the denoised synthetic images (214). These images are the result of the processing done by the U-Net, where the noise has been reduced or eliminated, and the images have been restored to a higher quality with the aim of preserving realistic motion and visual coherence. In some implementations, the process shown in FIG. 2 can be iteratively performed for a number of denoising time steps before proceeding with other operations (e.g., spatial super resolution).

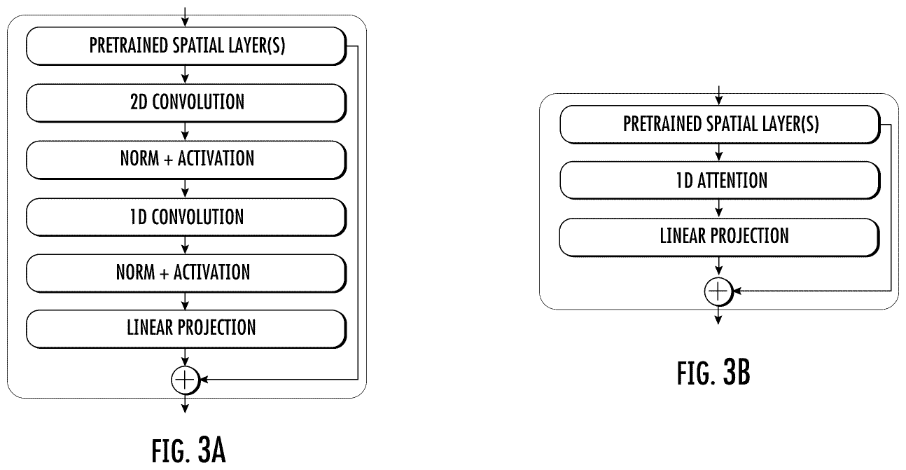

Thus, some implementations interleave temporal blocks in the T2I architecture, and insert temporal down- and up-sampling modules following each pre-trained spatial resizing module. The temporal blocks can include temporal convolutions (see, e.g., FIG. 3A) and temporal attention (see e.g., FIG. 3B). Specifically, in all levels except for the coarsest, some example implemetnations insert factorized space-time convolutions (see, e.g., FIG. 3A) which allow increasing the non-linearities in the network compared to full-3D convolutions while reducing the computational costs, and increasing the expressiveness compared to 1D convolutions. As the computational requirements of temporal attention scale quadratically with the number of frames, some example implementations incorporate temporal attention only at the coarsest resolution, which contains a space-time compressed representation of the video. Operating on the low dimensional feature map allows some example implementations to stack several temporal attention blocks with limited computational overhead.

Some example implementations train the newly added parameters, and keep the weights of the pre-trained T2I fixed. Notably, one example inflation approach ensures that at initialization, the T2V model is equivalent to the pre-trained T2I model, i.e., generates videos as a collection of independent image samples. However, in some instances, it is impossible to satisfy this property due to the temporal down- and up-sampling blocks. In some implementations, initializing these blocks such that they perform nearest-neighbor down- and up-sampling operations results with a good starting point.

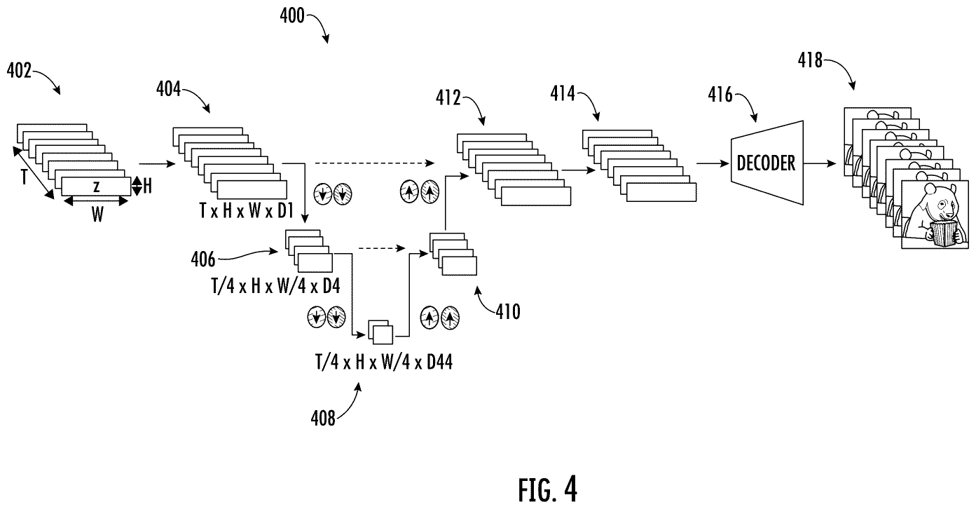

FIG. 4 illustrates an example space-time U-Net (400) which operates in the latent space of the video. This figure details the components of the U-Net (400) and the process flow from noisy latent inputs to denoised synthetic images via a decoding step.

In the example illustrated in FIG. 4, the U-Net (400) starts with noisy latent inputs (402) instead of raw pixel data. These inputs are noisy representations of the video data in a latent space.

A first convolution-based block (404) performs a first spatial and temporal downsampling on the noisy latent inputs (402). Downsampling in the latent space reduces the dimensionality of the data, which can help in reducing noise and computational complexity for further processing.

Continuing the process, a second convolution-based block (406) performs additional spatial and temporal downsampling. This step further abstracts the latent representations, allowing the network to focus on the most salient features that are relevant for reconstructing the video.

An attention-based block (408) selectively focuses on different parts of the latent representations. It can prioritize certain features over others, which is particularly useful for capturing complex dependencies within the video data.

A third convolution-based block (410) initiates the reconstruction process by performing the first spatial and temporal upsampling in the latent space. Upsampling increases the resolution of the latent representations, preparing them for further refinement.

A fourth convolution-based block (412) carries out a second spatial and temporal upsampling. This operation continues to enhance the detail in the latent representations, moving closer to the final output.

As a result of the processing through the U-Net (400), denoised latent outputs (414) are produced. These outputs are cleaner versions of the original noisy latent inputs and contain the information necessary to reconstruct denoised synthetic video frames. In some implementations, the flow shown between (402)-(414) can be performed iteratively over a number of denoising time steps before proceeding with the decoding described below.

A decoder (416) can transform the denoised latent outputs (414) into denoised synthetic images (418). In some implementations, the decoder can be implemented as a convolutional neural network. In some implementations, the decoder can also include capabilities to perform temporal downsampling and upsampling as part of the decoding process.

The final product of the U-Net (400) and the decoder (416) is the denoised synthetic images (418). These images are now in the pixel space and represent the clean, high-quality frames of the video that have been reconstructed from the latent space representations.

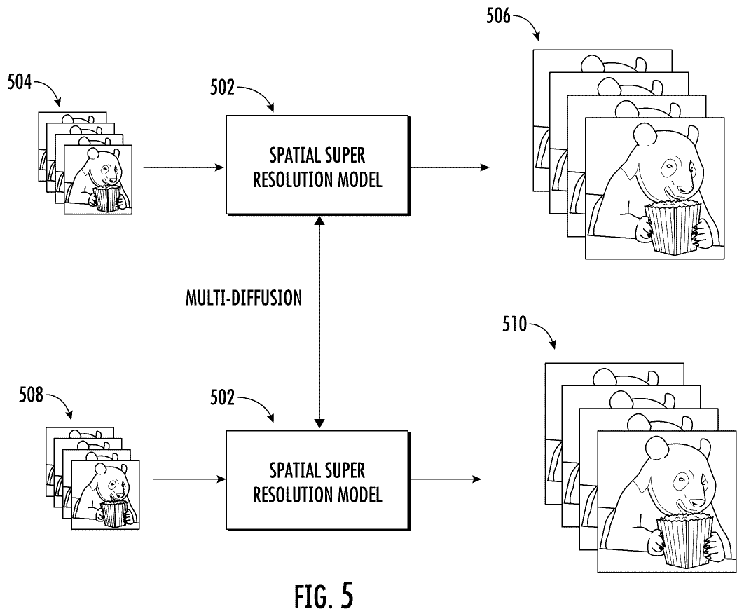

FIG. 5 in the patent application depicts the functioning of a spatial super-resolution model (502), which is designed to enhance the resolution of groups of low-resolution images to produce high-resolution counterparts. The figure illustrates the application of the model (502) to two separate groups of low-resolution images and the use of a multi-diffusion constraint to ensure consistency between the resulting high-resolution images.

Specifically, the spatial super-resolution model (502) is responsible for converting low-resolution images into high-resolution images. The model (502) is designed to process video frames and increase their spatial resolution, adding details and improving image quality.

The first group of low-resolution images (504) represents an initial set of low-resolution images that are fed into the spatial super-resolution model (502). These images are part of the video data that require resolution enhancement.

After processing by the model (502), the first group of low-resolution images (504) is transformed into a first group of high-resolution images (506). These high-resolution images have a greater level of detail and clarity compared to their low-resolution counterparts. Thus, the terms “low resolution” and “high resolution” may be terms of relative resolution (e.g., in the context of a super-resolution model a low resolution image may be an input and a high resolution image may be an output with a relatively larger resolution than the lower resolution input).

The second group of low-resolution images (508) represents another set of low-resolution images that are also input into the spatial super-resolution model (502). The second group of low-resolution images (508) may overlap with the first group (504), meaning that some images are shared between the two groups.

In some implementations, the first group of low-resolution images (504) and the second group of low-resolution images (508) can be respective subsets (e.g., overlapping subsets) of a larger number of image frames that were simultaneously output by a diffusion model (e.g., the space-time U-Net model illustrated in FIG. 2). To provide an example, an example space-time U-Net model can simultaneously generate 80 low-resolution frames (e.g., 5 seconds worth of video). These 80 low-resolution frames can be organized into groups (e.g., overlapping groups) of 8 frames (e.g., with an overlap of 2 frames per consecutive group).

The spatial super-resolution model (502) processes the second group of low-resolution images (508) to produce a second group of high-resolution images (510). As with the first group, these images are now enhanced in resolution and detail.

FIG. 5 also illustrates the application of a multi-diffusion constraint during the processing by the model (502). This constraint is applied to ensure that the transition between the first group of high-resolution images (506) and the second group of high-resolution images (510) is seamless and consistent. The multi-diffusion constraint helps to maintain coherence across the video frames, especially where the groups of images overlap. This is beneficial for video content, as any inconsistency between frames can lead to noticeable artifacts or jarring transitions. As one example, at each generation step, the noisy input video J∈ [symbol] ^{H×W×T×3} can be split into a set of overlapping segments {Jᵢ}ᵢ₌₁^{N}, where Jᵢ∈ [symbol] ^{H×W×T×3} is the i^{th} segment, which has temporal duration T′<T. To reconcile the per-segment SSR predictions, {ϕ(Jᵢ)}=ᵢ₌₁^{N}, some example implementations can define the result of the denoising step to be the solution of the optimization problem:

$$arg {min}_{{J}^{′}} {\sum }_{i = 1}^{n} {‖ {J}^{′} - Φ ( {J}_{i} ) ‖}^{2} .$$

The solution to this problem is given by linearly combining the predictions over overlapping windows.

### Example Use Cases

One example application is stylized generation. Recall that some example implementations only train the newly-added temporal layers and keep the pre-trained T2I weights fixed. Previous work showed that substituting the T2I weights with a model customized for a specific style allows to generate videos with the desired style. It was observed that this simple “plug-and-play” approach often results in distorted or static videos. This may be caused by the significant deviation in the distribution of the input to the temporal layers from the fine-tuned spatial layers.

Some example implementations strike a balance between style and motion by linearly interpolating between the fine-tuned T2I weights, W_{style}, and the original T2I weights, W_{orig}. Specifically, we construct the interpolated weights as Wᵢₙₜₑᵣₚₒₗₐₜₑ=α·W_{style}+(1−α)·W_{orig}. The interpolation coefficient (e.g., α∈[0.5,1]) can be chosen manually.

Another example application is conditional generation. Some example implementations extend the proposed model to video generation conditioned on additional input signals (e.g., image or mask). Some example implementations achieve this by modifying the model to take as input two signals in addition to the noisy video J∈ [symbol] ^{T×H×W×3} and a driving text prompt. Specifically, some example implementations add a masked conditioning video C∈ [symbol] ^{T×H×W×3} and its corresponding binary mask M∈ [symbol] ^{T×H×W×1}, such that the overall input to the model is the concatenated tensor <J, C, M>∈ [symbol] ^{T×H×W×7}. Some example implementations expand the channel dimension of the first convolution layer from 3 to 7 in order to accommodate the modified input shape and fine-tune the proposed base T2V model to denoise J based on C, M. During this fine-tuning process, some example implementations take J to be the noisy version of the training video, and C to be a masked version of the clean video. This encourages the model to learn to copy the unmasked information in C to the output video while only animating the masked content, as desired.

Another example is image-to-video. In this case, the first frame of the video is given as input. The conditioning signal C contains this first frame followed by blank frames for the rest of the video. The corresponding mask M contains ones (i.e., unmasked content) for the first frame and zeros (i.e., masked content) for the rest of the video. The proposed model can generate videos that start with the desired first frame, and exhibit intricate coherent motion across the entire video duration.

Another example is inpainting. In some inpainting examples, the conditioning signals are a user-provided video C and a mask M that describes the region to complete in the video. Note that the inpainting application can be used for object replacement/insertion as well as for localized editing. The effect is a seamless and natural completion of the masked region, with contents guided by the text prompt.

Another example is cinemagraphs. Some example implementations can perform the application of animating the content of an image only within a specific user-provided region. The conditioning signal C is the input image duplicated across the entire video, while the mask M contains ones for the entire first frame (i.e., the first frame is unmasked), and for the other frames, the mask contains ones only outside the user-provided region (i.e., the other frames are masked inside the region we wish to animate). Since the first frame remains unmasked, the animated content is encouraged to maintain the appearance from the conditioning image.

### Example Devices and Systems

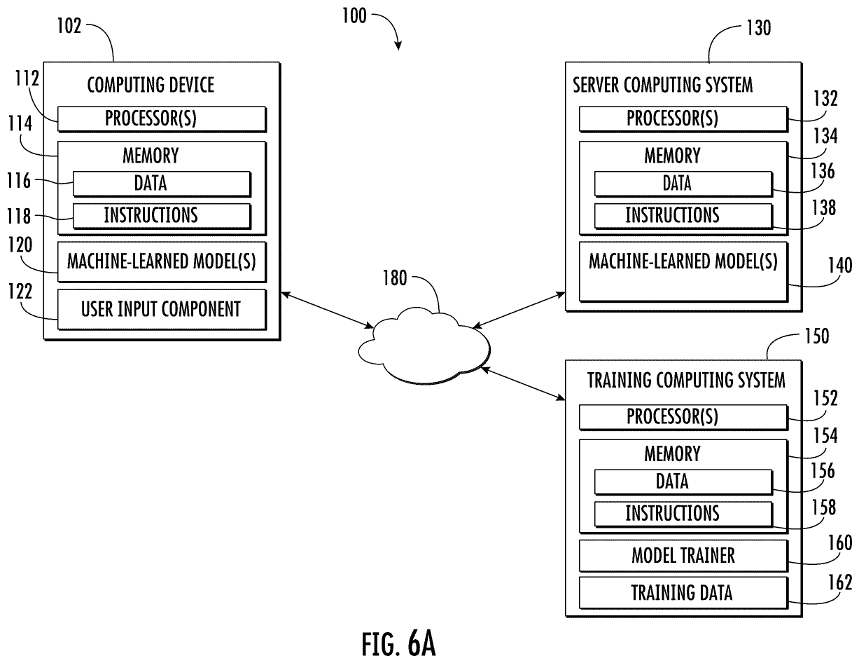

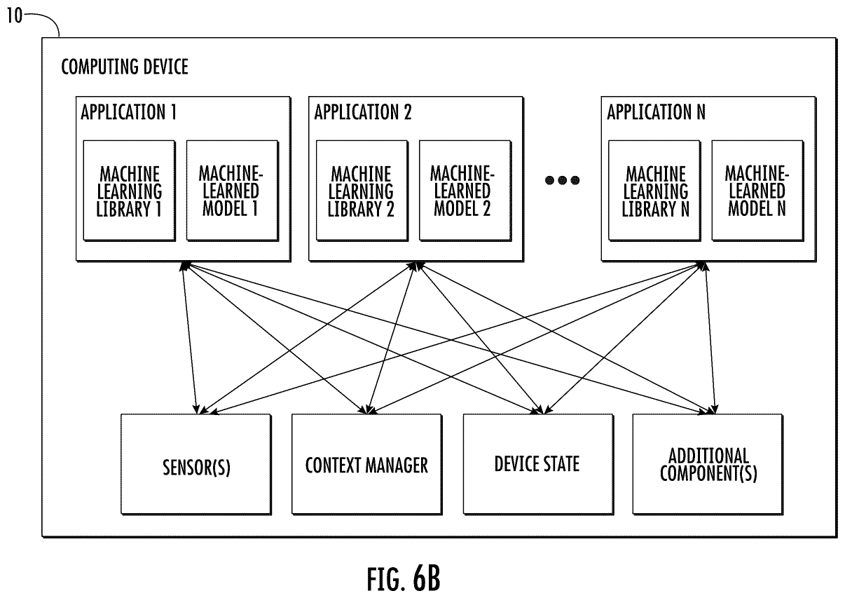

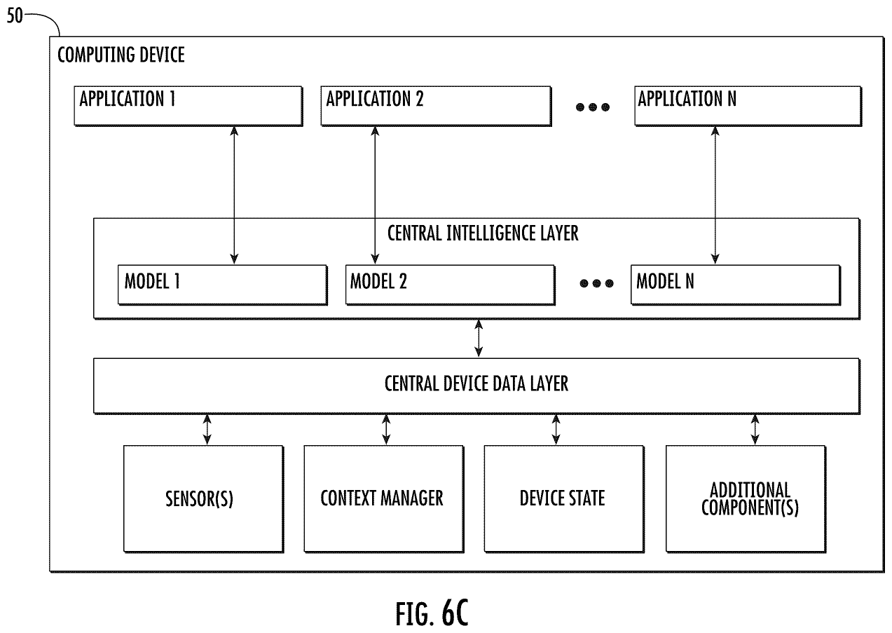

FIG. 6A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-5.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel video generation across multiple instances of inputs).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a video generation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-5.

One example type of machine learning model (e.g., model 120 and/or 140) is a denoising diffusion model (or “diffusion model”). A denoising diffusion model can be defined as a type of generative model that learns to progressively remove noise from a set of input data to generate new data samples. A comprehensive discussion of diffusion models is provided by Yang L., Zhang Z., Song Y., Hong S., Xu R., Zhao Y., Zhang W., Cui B., and Yang M., Diffusion Models: A Comprehensive Survey of Methods and Applications, arXiv: 2209.00796 [cs.LG]. See also, Sohl-Dickstein, J., Weiss, E., Maheswaranathan, N., & Ganguli, S. (2015). Deep Unsupervised Learning using Nonequilibrium Thermodynamics. In International Conference on Machine Learning (ICML); Song, Y., & Ermon, S. (2019). Generative Modeling by Estimating Gradients of the Data Distribution. In Advances in Neural Information Processing Systems (NeurIPS); Ho, J., Jain, A., & Abbeel, P. (2020). Denoising Diffusion Probabilistic Models. In Advances in Neural Information Processing Systems (NeurIPS); and Song, Y., Sohl-Dickstein, J., Kingma, D. P., Kumar, A., Ermon, S., & Poole, B. (2020). Score-Based Generative Modeling through Stochastic Differential Equations. In International Conference on Learning Representations (ICLR).

More particularly, in some implementations, the diffusion process of a denoising diffusion model can include both forward and reverse diffusion phases. The forward diffusion phase can include gradually adding noise (e.g., Gaussian noise) to data over a series of time steps. This transformation can lead to the data eventually resembling pure noise. For example, in the context of image processing, an initially clear image can incrementally receive noise until it is indistinguishable from random noise. In some implementations, this step-by-step addition of noise can be parameterized by a variance schedule that controls the noise level at each step.

Conversely, the reverse diffusion phase can include systematically removing the noise added during the forward diffusion to reconstruct the original data sample or to generate new data samples. This phase can use a trained neural network model to predict the noise that was added (or conversely, that should be removed) at each step and subtract it from the noisy data. For instance, starting from a purely noisy image, the model can iteratively denoise the image, progressively restoring details until a clear image is obtained.

This process of reverse diffusion can be guided by learning from a set of training data, where the model learns the optimal way to remove noise and recover data. The ability to reverse the noise addition effectively allows the generation of new data samples that are similar to the training data and/or modified according to specified conditions. In particular, in the learned reverse diffusion process, the diffusion model can be used to generate new samples that can either replicate the original or produce variations based on the learned data distribution.

In some implementations, denoising diffusion models can operate in either pixel space or latent space, each offering distinct advantages depending on the application requirements. Operating in pixel space means that the model directly manipulates and generates data in its original form, such as raw pixel values for images. For example, when generating images, the diffusion process can add or remove noise directly at the pixel level, allowing the model to learn and reproduce fine-grained details that are visible in the pixel data.

Alternatively, operating in latent space can include transforming the data into a compressed, abstract representation before applying the diffusion process. This can be beneficial for handling high-dimensional data or for improving the computational efficiency of the model. For instance, an image can be encoded into a lower-dimensional latent representation using an encoder network, and the diffusion process can then be applied in this latent space. The denoised latent representation can subsequently be decoded back into pixel space to produce the final output image. This approach can reduce the computational load during the training and sampling phases and can sometimes help in capturing higher-level abstract features of the data that are not immediately apparent in the pixel space.

In some implementations, denoising diffusion models can utilize probability distributions to manage the transformation of data throughout the diffusion process. As one example, Gaussian distributions can be employed in the forward diffusion phase, where noise added to the data is typically modeled as Gaussian. This method can be beneficial for applications like image processing or audio synthesis, where the gradual addition of Gaussian noise helps in creating a smooth transition from original data to a noise-dominated state. However, the model can also be designed to use other types of noise distributions as part of its stochastic process.

In the reverse phase, learned transition distributions can guide the denoising steps. Specifically, a parameterized model (e.g., neural network) can be used to predict the noise to be removed at each step of the reverse phase.

Model parameters can refer to parameter values within the denoising diffusion model that can be learned from training data to optimize the performance of the denoising diffusion model. These parameters can include weights of the neural networks used to predict noise in the reverse diffusion process, as well as parameters defining the noise schedule in the forward process.

The architecture of an example denoising diffusion model can include one or more neural networks. The neural networks can be trained to parameterize the transition kernels in the reverse Markov chain. As examples, the architecture of a denoising diffusion model can incorporate various types of neural networks, such as Convolutional Neural Networks (CNNs) or Recurrent Neural Networks (RNNs).

As a specific example, in some implementations, the neural network architecture can take the form of a U-Net. The U-Net architecture is characterized by its U-shaped structure, which includes a contracting path and an expansive path. The contracting path follows the typical architecture of a convolutional network, including repeated application of convolutions, followed by pooling operations that reduce the spatial dimensions of the feature maps. The expansive path of the U-Net, on the other hand, can include a series of up-convolutions and concatenations with high-resolution features from the contracting path. This can be achieved through skip connections that directly connect corresponding layers in the contracting path to layers in the expansive path.

More generally, the neural network architecture in denoising diffusion models can include multiple layers that can include various types of activation functions. These functions introduce non-linearities that enable the network to capture and learn complex data patterns effectively, although the specific choices of layers and activations can vary based on the model design and application requirements.

Additionally, the architecture can include special components like residual blocks and attention mechanisms, which can enhance the model's performance. Residual blocks can help in training deeper networks by allowing gradients to flow through the network more effectively. Attention mechanisms can provide a means for the model to focus on specific parts of the input data, which is advantageous for applications such as language translation or detailed image synthesis, where contextual understanding significantly impacts the quality of the output. These components are configurable and can be integrated into the neural network architecture to address specific challenges posed by the complexity of the data and the requirements of the generative task.

In some implementations, the training process of a denoising diffusion model can be oriented towards specific learning objectives. These objectives can include minimizing the difference between the original data and the data reconstructed after the reverse diffusion process. Specifically, in some implementations, an objective can include minimizing the Kullback-Leibler divergence between the joint distributions of the forward and reverse Markov chains to ensure that the reverse process effectively reconstructs or generates data that closely matches the training data. As another example, in image processing applications, the objective may be to minimize the pixel-wise mean squared error between the original and reconstructed images. Additionally, the model can be trained to optimize the likelihood of the data given the model, which can enhance the model's ability to generate new samples that are indistinguishable from real data.

Various strategies can be used to perform the training process for diffusion models. Gradient descent algorithms, such as stochastic gradient descent (SGD) or Adam, can be utilized to update the model's parameters. Moreover, learning rate schedules can be implemented to adjust the learning rate during training, which can help in stabilizing the training process and improving convergence. For instance, a learning rate that decreases gradually as training progresses can lead to more stable and reliable model performance.

Various loss functions can be used guide the training of denoising diffusion models. Example loss functions include the mean squared error (MSE) for regression tasks or cross-entropy loss for classification tasks within the model. Additionally, variational lower bounds, such as the evidence lower bound (ELBO), can be used to train the model under a variational inference framework. These loss functions can help in quantifying the discrepancy between the generated samples and the real data, guiding the model to produce outputs that closely resemble the target distribution.

In some implementations, temperature sampling in denoising diffusion models can be used to control the randomness of the generation process. By adjusting the temperature parameter, one can modify the variance of the noise used in the sampling steps, which can affect the sharpness and diversity of the generated outputs. For instance, a lower temperature can result in less noisy and more precise samples, whereas a higher temperature can increase sample diversity but may also introduce more noise and reduce sample quality.

In some implementations, conditional generation can allow the generation of data samples based on specific conditions or attributes. Conditional generation in denoising diffusion models can include modifying the reverse diffusion process based on additional inputs (e.g., conditioning inputs) such as class labels or text descriptions, which guide the model to generate data samples that are more likely to meet specific conditions. This can be implemented by conditioning the model on additional inputs such as class labels, text descriptions, or other data modalities. For example, in a model trained on a dataset of images and their corresponding captions, the model can generate images that correspond to a given textual description, enabling targeted image synthesis.

More particularly, denoising diffusion models can be conditioned using various types of data to guide the generation process towards specific outcomes. One common type of conditioning data is text. For example, in generating images from descriptions, the model can use textual inputs like “a sunny beach” or “a snowy mountain” to generate corresponding images. The text can be processed using natural language processing techniques to transform it into a format that the model can utilize effectively during the generation process.

For example, one type of conditioning data can include text embeddings. Text embeddings are vector representations of text that capture semantic meanings, which can be derived from pre-trained language models such as BERT or CLIP. These embeddings can provide a denser and potentially more informative representation of text than raw text inputs. For instance, in a diffusion model tasked with generating music based on mood descriptions, embeddings of words like “joyful” or “melancholic” can guide the audio generation process to produce music that reflects these moods.

Additionally, conditioning can also include using categorical labels or tags. This approach can be particularly useful in scenarios where the data needs to conform to specific categories or classes.

Classifier-free guidance is a technique that can enhance the control over the sample generation process without the need for an additional classifier model. This can be achieved by modifying the guidance scale during the reverse diffusion process, which adjusts the influence of the learned conditional model. For instance, by increasing the guidance scale, the model can produce samples that more closely align with the specified conditions, improving the fidelity of generated samples that meet desired criteria without the computational overhead of training and integrating a separate classifier.

In some implementations, denoising diffusion models can integrate with other generative models to form hybrid models. For instance, combining a denoising diffusion model with a Generative Adversarial Network (GAN) can leverage the strengths of both models, where the diffusion model can ensure diversity and coverage of the data distribution, and the GAN can refine the sharpness and realism of the generated samples. Another example can include integration with Variational Autoencoders (VAEs) to improve the latent space representation and stability of the generation process.

Efficiency improvements are beneficial aspects of denoising diffusion models. One way to achieve this is by reducing the number of diffusion steps required to generate high-quality samples. For example, sophisticated training techniques such as curriculum learning can be employed to gradually train the model on easier tasks (fewer diffusion steps) and increase complexity (more steps) as the model's performance improves. Additionally, architectural optimizations such as implementing more efficient neural network layers or utilizing advanced activation functions can decrease computational load and improve processing speed during both training and generation phases.

Noise scheduling strategies can improve the performance of denoising diffusion models. By carefully designing the noise schedule—the variance of noise added at each diffusion step—models can achieve faster convergence and improved sample quality. For example, using a learned noise schedule, where the model itself optimizes the noise levels during training based on the data, can result in more efficient training and potentially better generation quality compared to fixed, predetermined noise schedules.

In some implementations, learned upsampling in denoising diffusion models can facilitate the generation of high-resolution outputs from lower-resolution inputs. This technique can be particularly useful in applications such as high-definition image generation or detailed audio synthesis. Learned upsampling can include additional model components that are trained to increase the resolution of generated samples through the reverse diffusion process, effectively enhancing the detail and quality of outputs without the need for externally provided high-resolution training data. In some cases, these additional learned components can be referred to as “super-resolution” models.

In some implementations, denoising diffusion models can be applied to the field of image synthesis, where they can generate high-quality, photorealistic images from a distribution of training data. For example, example models can be used to create new images of landscapes, animals, or even fictional characters by learning from a dataset composed of similar images. The model can add noise to these images and then learn to reverse this process, effectively enabling the generation of new, unique images that maintain the characteristics of the original dataset.

Denoising diffusion models can also be utilized in audio generation. They can generate clear and coherent audio clips from noisy initial data or even from scratch. For instance, in the music industry, example models can help in creating new musical compositions by learning from various genres and styles. Similarly, in speech synthesis, denoising diffusion models can generate human-like speech from text inputs, which can be particularly beneficial for virtual assistants and other AI-driven communication tools.

Other potential use cases of denoising diffusion models extend across various fields including drug discovery, where example models can help in generating molecular structures that could lead to new pharmaceuticals. Additionally, in the field of autonomous vehicles, denoising diffusion models can be used to enhance the processing of sensor data, improving the vehicle's ability to interpret and react to its environment.

In some implementations, the performance of denoising diffusion models can be evaluated using various metrics that assess the quality and diversity of generated samples. The Inception Score (IS) is one such metric that can be used; it measures how distinguishable the generated classes are and the confidence of the classification. For example, a higher Inception Score indicates that the generated images are both diverse across classes and each image is distinctly recognized by a classifier as belonging to a specific class. Another commonly used metric is the Fréchet Inception Distance (FID), which assesses the similarity between the distribution of generated samples and real samples, based on features extracted by an Inception network. A lower FID indicates that the generated samples are more similar to the real samples, suggesting higher quality of the generated data.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, raw video data, optionally with some conditioning input like text.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 6A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 6B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 6B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 6C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 6C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 6C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to perform video generation, the method comprising:
generating, by a computing system comprising one or more computing devices, a plurality of noisy inputs that respectively correspond to a plurality of timestamps that span a temporal dimension of a video;
simultaneously processing, by the computing system, the plurality of noisy inputs with a machine-learned denoising diffusion model to simultaneously generate, as an output of the machine-learned denoising diffusion model, a plurality of synthetic frames for the video that respectively correspond to the plurality of timestamps of the video,
wherein the machine-learned denoising diffusion model comprises a plurality of layers,
wherein at least a first layer of the plurality of layers performs a temporal downsampling operation to generate a first layer output having a reduced size in the temporal dimension, and
wherein at least a second layer of the plurality of layers performs a temporal upsampling operation to generate a second layer output having an increased size in the temporal dimension; and
providing, by the computing system, the video as an output.

2. The computer-implemented method of claim 1, wherein the plurality of synthetic frames simultaneously generated by the machine-learned denoising diffusion model comprise an entirety of the video.

3. The computer-implemented method of claim 1, wherein the machine-learned denoising diffusion model comprises a space-time U-Net.

4. The computer-implemented method of claim 3, wherein the space-time U-Net comprises a pre-trained U-Net that has been inflated with temporal layers.

5. The computer-implemented method of claim 1, wherein an initial layer of the machine-learned denoising diffusion model and a final layer of the machine-learned denoising diffusion model each have a size in the temporal dimension that matches a number of frames included in the video.

6. The computer-implemented method of claim 1, wherein the plurality of layers comprise two or more convolution-based inflation blocks and at least one attention-based inflation block, wherein each of the two or more convolution-based inflation blocks and the at least one attention-based inflation block combine pre-trained spatial layers with added temporal layers.

7. The computer-implemented method of claim 6, wherein each convolution-based inflation block comprises a 2D convolution followed by a 1D convolution with temporal downsampling or temporal upsampling, and wherein each attention-based inflation block comprises a 1D attention operation with temporal upsampling.

8. The computer-implemented method of claim 1, wherein the machine-learned denoising diffusion model operates in a pixel-space of the video.

9. The computer-implemented method of claim 1, wherein the machine-learned denoising diffusion model operates in a latent-space of the video, and wherein the machine-learned denoising diffusion model comprises at least a decoder to transform from the latent-space of the video to a pixel-space of the video.

10. The computer-implemented method of claim 1, wherein:
the plurality of synthetic frames simultaneously generated by the machine-learned denoising diffusion model comprise a plurality of low resolution synthetic frames, and
the method further comprises, prior to providing the video as an output: processing, by the computing system, the plurality of low resolution synthetic frames with a machine-learned spatial-super resolution model to generate a plurality of high resolution synthetic frames for the video.

11. The computer-implemented method of claim 10, wherein processing, by the computing system, the plurality of low resolution synthetic frames with the machine-learned spatial-super resolution model comprises processing, by the computing system with the machine-learned spatial-super resolution model, each of a plurality of groups of the low resolution synthetic frames that respectively correspond to a plurality of temporal windows.

12. The computer-implemented method of claim 11, wherein processing, by the computing system with the machine-learned spatial-super resolution model, each of the plurality of groups of the low resolution synthetic frames comprises performing, by the computing system, multi-diffusion across the temporal dimension of two or more of the plurality of groups.

13. The computer-implemented method of claim 12, wherein the plurality of temporal windows are overlapping, and wherein performing, by the computing system, multi-diffusion comprises performing, by the computing system, multi-diffusion on overlapping temporal portions of the two or more of the plurality of groups.

14. The computer-implemented method of claim 1, further comprising:
receiving, by the computing system, a conditioning input; and
conditioning, by the computing system, the machine-learned denoising diffusion model on the conditioning input.

15. The computer-implemented method of claim 14, wherein the conditioning input comprises a textual input.

16. The computer-implemented method of claim 14, wherein the conditioning input comprises an image input.

17. The computer-implemented method of claim 16, wherein the image input comprises a masked image input.

18. The computer-implemented method of claim 1, wherein the machine-learned denoising diffusion model comprises a plurality of weights that have been derived by interpolating between a base set of weights and a style-specific set of weights.

19. A computing system comprising one or more processors and one or more non-transitory computer-readable media that store computer-readable instructions for performing operations, the operations comprising:
generating, by a computing system comprising one or more computing devices, a plurality of noisy inputs that respectively correspond to a plurality of timestamps that span a temporal dimension of a video;
simultaneously processing, by the computing system, the plurality of noisy inputs with a machine-learned denoising diffusion model to simultaneously generate, as an output of the machine-learned denoising diffusion model, a plurality of synthetic frames for the video that respectively correspond to the plurality of timestamps of the video,
wherein the machine-learned denoising diffusion model comprises a plurality of layers,
wherein at least a first layer of the plurality of layers performs a temporal downsampling operation to generate a first layer output having a reduced size in the temporal dimension, and
wherein at least a second layer of the plurality of layers performs a temporal upsampling operation to generate a second layer output having an increased size in the temporal dimension; and
providing, by the computing system, the video as an output.

20. One or more non-transitory computer-readable media that collectively store:
a machine-learned denoising diffusion model configured to perform operations, the operations comprising:
receiving a plurality of noisy inputs that respectively correspond to a plurality of timestamps that span a temporal dimension of a video;
simultaneously processing the plurality of noisy inputs to simultaneously generate, as an output, a plurality of synthetic frames for the video that respectively correspond to the plurality of timestamps of the video,
wherein the machine-learned denoising diffusion model comprises a plurality of layers,
wherein at least a first layer of the plurality of layers performs a temporal downsampling operation to generate a first layer output having a reduced size in the temporal dimension, and
wherein at least a second layer of the plurality of layers performs a temporal upsampling operation to generate a second layer output having an increased size in the temporal dimension; and
providing the video as the output of the model.
